(19) United States
(12) Patent Application Publication
(10) Pub. No.: US 2021/0321681 A1
(43) Pub. Date: Oct. 21, 2021

(54) Heated Jacket Assembly

(71) Applicant: Logan Berges, Los Angeles, CA (US)

(72) Inventor: Logan Berges, Los Angeles, CA (US)

(21) Appl. No.: 16/854,311

(22) Filed: Apr. 21, 2020

(51) Int. Cl. A41D 13/005; A41D 1/00

(52) U.S. Cl. CPC A41D 13/0051; A41D 1/002

(57) ABSTRACT

A heated jacket assembly for keeping a user warm includes a jacket that is wearable on a user when the user needs to keep warm. A heating element is integrated into the jacket and the heating element comprises a carbon fiber material to produce heat when exposed to an electrical current. A remote control is provided that is carried by the user. The remote control is in wireless communication with the heating element for adjusting the temperature of the heating element and to turn the heating element on and off.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to heated jacket devices and more particularly pertains to a new heated jacket device for keeping a user warm.

### (2) Description of Related Art Including Information Disclosed Under 37 CFR 1.97 and 1.98

The prior art relates to heated jacket devices including a vest that has an electric heating element being integrated therein for warming a user. The prior art discloses a variety of jackets that have an electric heating element being integrated therein for warming a user. In no case does the prior art disclose a jacket, with a hood, that has an electric heating element and a remote control for the heating element.

### BRIEF SUMMARY OF THE INVENTION

An embodiment of the disclosure meets the needs presented above by generally comprising a jacket that is wearable on a user when the user needs to keep warm.

A heating element is integrated into the jacket and the heating element comprises a carbon fiber material to produce heat when exposed to an electrical current. A remote control is provided that is carried by the user. The remote control is in wireless communication with the heating element for adjusting the temperature of the heating element and to turn the heating element on and off.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front phantom view of a heated jacket assembly according to an embodiment of the disclosure.

FIG. 2 is a back phantom view of an embodiment of the disclosure.

FIG. 3 is a detail view taken from circle 3 of FIG. 1 of an embodiment of the disclosure.

FIG. 4 is a schematic view of an embodiment of the disclosure.

### DETAILED DESCRIPTION OF THE INVENTION

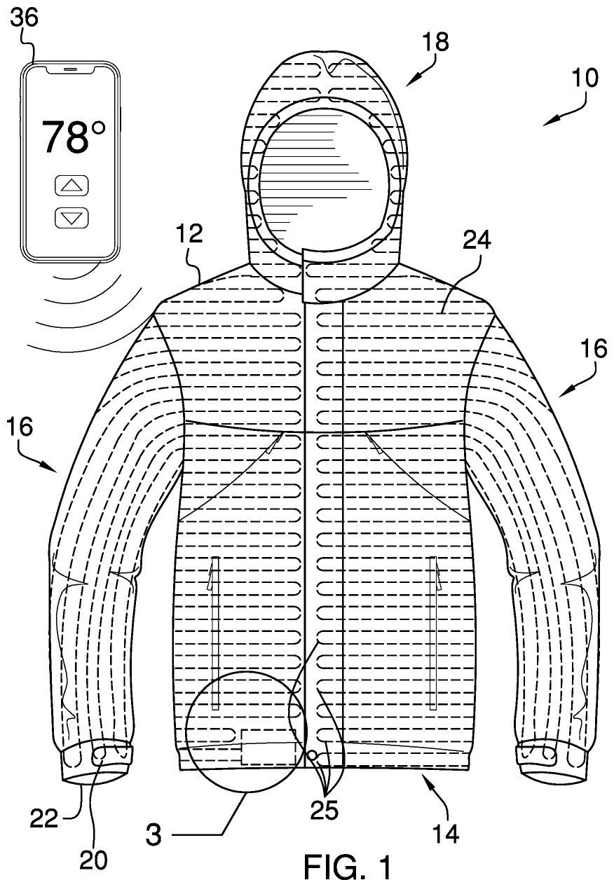

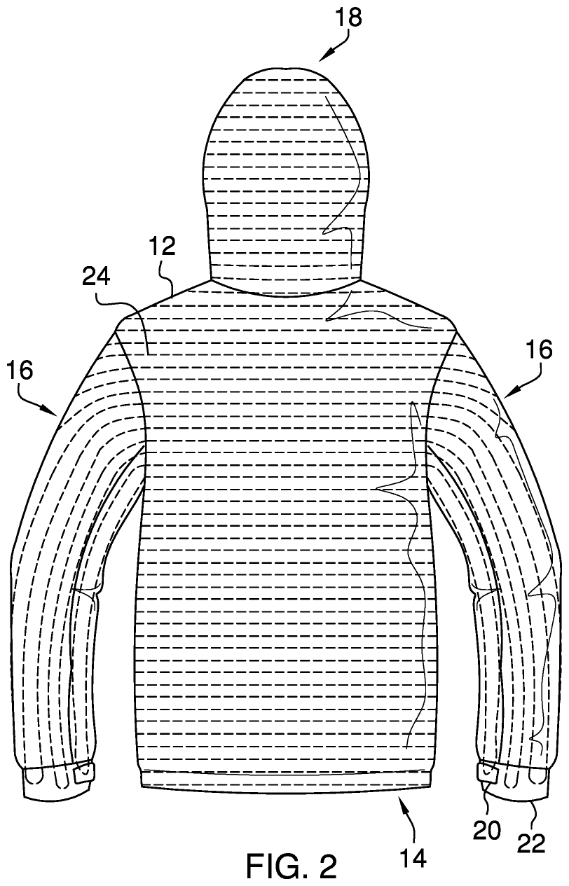

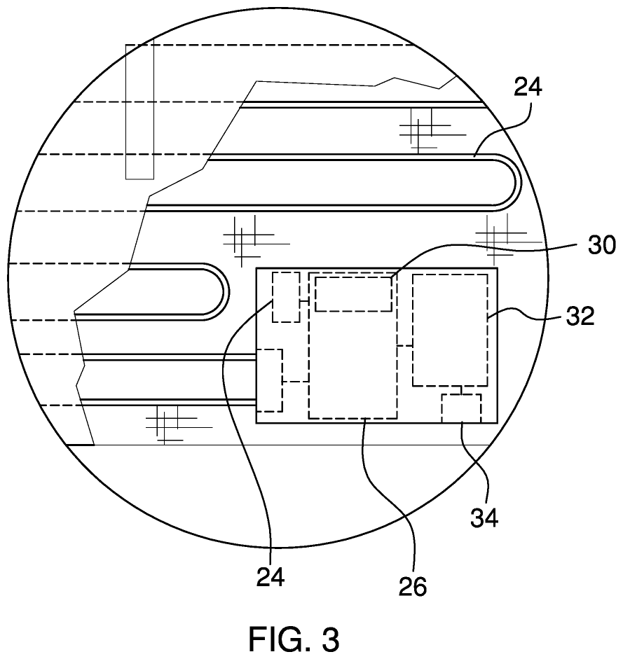

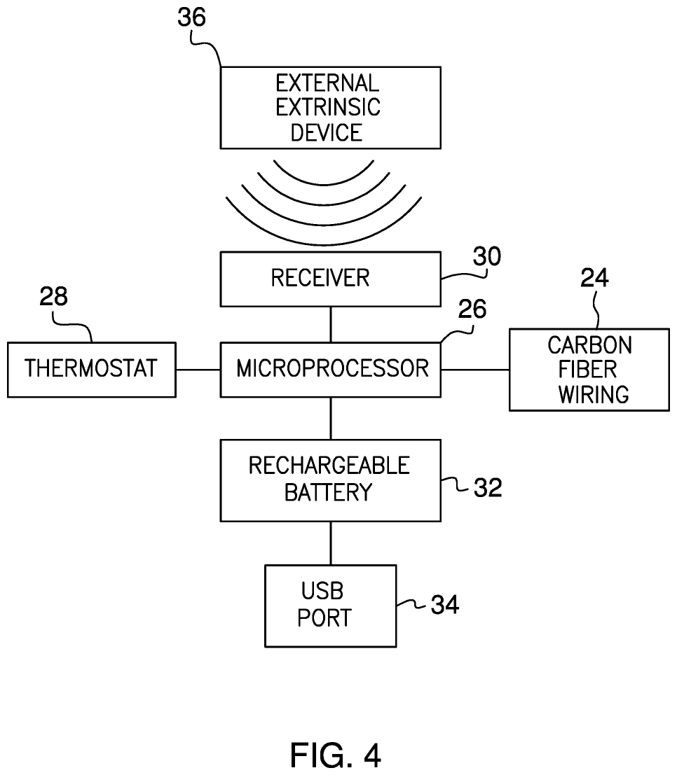

With reference now to the drawings, and in particular to FIGS. 1 through 4 thereof, a new heated jacket device embodying the principles and concepts of an embodiment of the disclosure and generally designated by the reference numeral 10 will be described.

As best illustrated in FIGS. 1 through 4, the heated jacket assembly 10 generally comprises a jacket 12 that is wearable on a user when the user needs to keep warm. The jacket 12 has a body 14, a pair of sleeves 16 and a hood 18. Each of the sleeves 16 may include a strap 20 on a cuff 22 of the sleeves 16 for adjusting the diameter of the cuff 22. Additionally, the jacket 12 may be comprised of a thermally insulated material for retaining body heat when the jacket 12 is worn.

A heating element 24 is provided and the heating element 24 is integrated into the jacket 12. The heating element 24 comprises a carbon fiber material to produce heat when exposed to an electrical current. Additionally, the carbon fiber material facilitates the heating element 24 to be deformed without breaking. In this way the heating element 24 facilitates normal movement while the jacket 12 is worn without risk of damaging the heating element 24. The heating element 24 is formed into a plurality of loops 25 that are distributed throughout each of the sleeves 16, the body 14 and the hood 18 to warm the entire top half of the user's body.

A control circuit 26 is integrated into the jacket 12 and the control circuit 26 is electrically coupled to the heating element 24. A temperature sensor 28 is integrated into the jacket 12 and the temperature sensor 28 is in thermal communication with the heating element 24. The temperature sensor 28 is electrically coupled to the control circuit 26. Moreover, the control circuit 26 turns the heating element 24 off when the temperature senses that the temperature of the heating element 24 has exceeded a pre-determined maximum temperature. The temperature sensor 28 may be an electronic temperature sensor 28 of any conventional design.

A receiver 30 is integrated into the jacket 12 and the receiver 30 is electrically coupled to the control circuit 26 and the receiver 30. The receiver 30 may comprise a radio frequency receiver or the like and the receiver 30 may employ Bluetooth communication protocols. A power supply 32 is integrated into the jacket 12, the power supply 32 is electrically coupled to the control circuit 26 and the power supply 32 comprises at least one battery. A charge port 34 may be integrated into the jacket 12, the charge port 34 may be electrically coupled to the power supply 32 and the charge port 34 may receive a charge cord for charging the power supply 32.

A remote control 36 is included that is carried by the user and the remote control 36 is in wireless communication with the receiver 30. The remote control 36 broadcasts a temperature command to the receiver 30 for defining the maximum temperature for the heating element 24. The remote control 36 broadcasts an on signal to the receiver 30 for turning on the heating element 24. Conversely, the remote control 36 broadcasts an off signal to the receiver 30 for turning off the heating element 24. The remote control 36 comprises a personal electronic device, such as a smart phone or the like, that employs Bluetooth communication protocols. In this way the remote control 36 can by synched with the receiver 30 for remotely controlling the heating element 24. Moreover, the remote control 36 stores operational software, such as a smart phone app, to facilitate operational control of the heating element 24.

In use, the jacket 12 is worn when the user needs to keep warm and the remote control 36 is manipulated to turn on the heating element 24. In this way the jacket 12 facilitates the user to be continuously warmed thereby enhancing comfort for the user. Additionally, the user can employ their personal electronic device, such as a smart phone, to remotely control the heating element 24. In this way the user can lower or raise the temperature at which the heating element 24 will operate.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A heated jacket assembly for keeping a person warm in a cold environment, said assembly comprising:
a jacket being wearable on a user when the user needs to keep warm;
a heating element being integrated into said jacket, said heating element comprising a carbon fiber material wherein said heating element is configured to produce heat when exposed to an electrical current; and
a remote control being carried by the user, said remote control being in wireless communication with said heating element for adjusting the temperature of said heating element and to turn said heating element on and off.

2. The assembly according to claim 1, wherein:
said jacket having a body, a pair of sleeves and a hood; and
said heating element is formed into a plurality of loops being distributed throughout each of said sleeves, said body and said hood wherein said heating element is configured to warm the entire top half of the user's body.

3. The assembly according to claim 1, further comprising control circuit being integrated into said jacket, said control circuit being electrically coupled to said heating element.

4. The assembly according to claim 3, further comprising a temperature sensor being integrated into said jacket, said temperature sensor being in thermal communication with said heating element, said temperature sensor being electrically coupled to said control circuit, said control circuit turning said heating element off when said temperature senses that the temperature of said heating element has exceeded a pre-determined maximum temperature.

5. The assembly according to claim 3, further comprising a receiver being integrated into said jacket, said receiver being electrically coupled to said control circuit.

6. The assembly according to claim 3, further comprising a power supply being integrated into said jacket, said power supply being electrically coupled to said control circuit, said power supply comprising at least one battery.

7. The assembly according to claim 5, wherein said remote control is in wireless communication with said receiver, said remote control broadcasting a temperature command to said receiver for defining the maximum temperature for said heating element, said remote control broadcasting an on signal to said receiver for turning on said heating element, said remote control broadcasting an off signal to said receiver for turning off said heating element.

8. A heated jacket assembly for keeping a person warm in a cold environment, said assembly comprising:
a jacket being wearable on a user when the user needs to keep warm, said jacket having a body, a pair of sleeves and a hood;
a heating element being integrated into said jacket, said heating element comprising a carbon fiber material wherein said heating element is configured to produce heat when exposed to an electrical current, said heating element being formed into a plurality of loops being distributed throughout each of said sleeves, said body and said hood wherein said heating element is configured to warm the entire top half of the user's body;
control circuit being integrated into said jacket, said control circuit being electrically coupled to said heating element;
a temperature sensor being integrated into said jacket, said temperature sensor being in thermal communication with said heating element, said temperature sensor being electrically coupled to said control circuit, said control circuit turning said heating element off when said temperature senses that the temperature of said heating element has exceeded a pre-determined maximum temperature;
a receiver being integrated into said jacket, said receiver being electrically coupled to said control circuit;
a power supply being integrated into said jacket, said power supply being electrically coupled to said control circuit, said power supply comprising at least one battery; and
a remote control being carried by the user, said remote control being in wireless communication with said receiver, said remote control broadcasting a temperature command to said receiver for defining the maximum temperature for said heating element, said remote control broadcasting an on signal to said receiver for turning on said heating element, said remote control broadcasting an off signal to said receiver for turning off said heating element.

9. The assembly according to claim 8, wherein said remote control comprises a personal electronic device, said personal electronic device storing operational software for controlling operational parameters of said heating element.
